(19) United States
(12) Patent Application Publication
(10) Pub. No.: US 2026/0009598 A1
(43) Pub. Date: Jan. 8, 2026

(54) VARIABLE LENGTH FIN HEAT EXCHANGER AND CORRESPONDING TURBOMACHINE

(71) Applicant: SAFRAN, Paris (FR)

(72) Inventor: Ephraïm TOUBIANA, MOISSY-CRAMAYEL (FR)

(73) Assignee: SAFRAN, Paris (FR)

(21) Appl. No.: 18/881,552

(22) PCT Filed: Jun. 29, 2023
(86) PCT No.: PCT/FR2023/050996

§ 371 Date: Jan. 6, 2025

(30) Foreign Application Priority Data
Jul. 8, 2022 (FR) FR2207031

(51) Int. Cl. F28F 3/04; B64D 33/08; F01D 25/12

(52) U.S. Cl. CPC F28F 3/04; B64D 33/08; F01D 25/12; F05D 2260/213

(57) ABSTRACT

A heat exchanger for a turbomachine of an aircraft, the heat exchanger having a plurality of fins intended to be swept by a first fluid in a first direction, the fins extending in a second direction between a first panel and a second panel, being arranged in several rows in a third direction, and being arranged in a staggered manner, each row of fins being parallel and connected to one another. The heat exchanger can be annular, centered on the third direction and can have an inner cylindrical surface defining an inlet and an outer cylindrical surface defining an outlet, and the fins can have a length which decreases radially in the heat exchanger, in the first direction, between the inner cylindrical surface and the outer cylindrical surface.

### FIELD OF THE INVENTION

The present invention relates to the general field of aeronautic. In particular, it is aimed at a heat exchanger for a turbomachine, in particular for an aircraft.

### TECHNICAL BACKGROUND

An aircraft turbomachine and an aircraft comprise various members and/or items of equipment that need to be lubricated and/or cooled for their correct operation or fluids that need to be cooled for the correct operation of the turbomachine. These members and/or items of equipment and/or fluids may be means for guiding the rotor in the turbomachine, electrical and/or electronic elements for electrical systems in the turbomachine of the aircraft, hot exhaust gases from the turbomachine configured to be introduced upstream of the combustion chamber, or systems for conditioning the interior spaces of the aircraft. The heat released by these members, items of equipment and/or fluids, which may be very high, is evacuated by heat exchange in the turbomachine and/or the aircraft.

The heat exchange is achieved using one or more heat exchangers installed in the turbomachine or the aircraft for various applications. Depending on the application, the heat exchangers generally use a cold source, which may be ambient air, an air from the secondary duct of the turbomachine, etc., and a hot source, which may be the fuel of the turbomachine, oil, bleed air collected from the low-pressure or high-pressure compressor of the turbomachine, or an air from the primary duct of the turbomachine.

The heat exchangers may be of the tube, fin, plate and fin type, etc. The plate and fin heat exchangers, particularly offset strip fins, are used in the turbomachines because of their low mass. These heat exchangers comprise rows of fins that are parallel to each other and fins that are arranged in staggered or offset pitches. The heat exchanger may be configured in several stages. Generally speaking, a first fluid, for example hot exhaust gases, and a second fluid, for example an air flow circulating in the turbomachine, pass through the heat exchanger in two different directions. An example of a plate and fin heat exchanger is described in the patent document FR3077630.

The prior art also comprises the following documents, U.S. Pat. Nos. 3,818,984, 2,792,200, US-A1-2021/0180886, U.S. Pat. No. 10,866,030, US-A1-2016/0054071, US-A1-2021/0222963, US-A1-2012/0216543, FR-A1-3097257, U.S. Pat. Nos. 2,429,508, and 8,601,791.

One of the problems observed in this type of heat exchanger applied in a turbomachine is the high pressure drop, due in particular to a high shape drag. It is difficult to increase the number of fins significantly to improve the performances of the turbomachine. In addition, a heat exchanger of this type, particularly one with several stages, has differences in flow circulation speed between the inlet and outlet of the heat exchanger. The cross-sectional area of the fluid passage may increase depending on the direction of fluid circulation in the heat exchanger. This results in a reduction in speed and an approximately linear increase in the hydraulic diameter of the exchange surface. As a result, the exchange coefficient will decrease and the overall exchange coefficient will vary as a function of the distance from the heat exchanger inlet, leading to an heterogeneity of the heat exchange and an imbalance in the convection heat resistances between the first and second fluids. The exchanger is generally sized so as to have an optimum convection heat resistance ratio. The optimum thermal resistance ratio depends on the nature of the two fluids, temperatures/pressures/flow rates and the permitted pressure drop for each of the fluids. This may be close to 1 if the fluids are of the same nature, with relatively similar temperature/pressure/flow rate conditions and pressure drops.

There is a need to resolve some or all of the above disadvantages.

### SUMMARY OF THE INVENTION

The aim of the present invention is to provide a heat exchanger that allows better optimisation of aerothermal performance while reducing pressure drops and avoiding a considerable impact on mass.

This objective is achieved in accordance with the invention by means of a heat exchanger for a turbomachine, in particular an aircraft turbomachine, having a longitudinal axis, the heat exchanger comprising a plurality of fins configured to be swept by a first fluid in a first direction, the fins extending in a second direction between a first panel and a second panel, the fins being arranged in a plurality of rows in a third direction and being staggered, each row of fins being parallel to one another and connected to one another, the heat exchanger being annular centered on the longitudinal axis and having an outer cylindrical surface defining an inlet to the heat exchanger and an outer cylindrical surface defining an outlet from the heat exchanger, and the successive fins in each row having a length which decreases radially in the heat exchanger in the first direction between the inner cylindrical surface and the outer cylindrical surface.

Thus, this solution allows to achieve the above-mentioned objective. In particular, by adapting the dimensions and characteristics of the exchange surfaces on the first fluid as a function of the distance from the central axis of the exchanger, the thermal performance of the heat exchanger is significantly improved. With this configuration, the overall exchange coefficient increases and is relatively homogeneous along the entire radial length of the heat exchanger by varying the exchange coefficient along the radial length of the first fluid side. By varying the length of the fins, it is also possible to compensate for the variation in cross-section and a variation in the speed of the flow of the first fluid in the heat exchanger.

The passage cross-sectional area increases with the radius of the heat exchanger (in cylindrical coordinates), resulting in a decrease in speed. Reducing the fin length will increase the exchange coefficient at iso-speed. The reduction in speed is compensated by the reduction in fin length.

The heat exchanger also comprises one or more of the following characteristics, taken alone or in combination:
the fins of each row are spaced apart by a pitch in the first direction, the pitch having a variation in the second direction.
the pitch decreases in the first direction from the inner cylindrical surface towards the outer cylindrical surface.
each fin has a height which increases from the inner cylindrical surface to the outer cylindrical surface.
the first panel, the second panel and the fins between the first and second panels form a stage, and in that the heat exchanger comprises several stages arranged around the third direction, the stages being spaced apart by passages configured for the circulation of a second fluid.
the heat exchanger comprises covers each closing one end of a passage, the covers extending between the first panel and the second panel.
the fins are connected alternately by top walls and base walls, the top walls and the base walls being connected respectively to the first and second panels.
the heat exchanger is formed in one-part (integrally made).
the length of each fin is defined linearly as a function of the mean radial coordinate of the fin and according to a parameter

$${λ}_{r} = \frac{L ( {R}_{min} )}{L ( {R}_{max} )} ,$$

where L is the length of the fin as a function of its radial position in cylindrical coordinates, Rmin is the minimum radius of the heat exchanger defined by the inner cylindrical surface, Rmax is the maximum radius of the heat exchanger defined by the outer cylindrical surface.
the heat exchanger comprises an inlet defined in the inner cylindrical surface through which the first fluid and/or the second fluid enters in the heat exchanger and an outlet defined in the outer cylindrical surface through which the first fluid and/or the second fluid evacuates from the heat exchanger.
the heat exchanger comprises an inlet defined in an upstream surface through which the second fluid enters the heat exchanger and an outlet defined in an opposite downstream surface along the longitudinal axis through which the second fluid evacuates the heat exchanger.

The invention also relates to a turbomachine comprising a heat exchanger having any one of the preceding characteristics, the first and second panels extending, on the one hand, along a radial axis perpendicular to the longitudinal axis X and, on the other hand, being arranged regularly around the longitudinal axis, the fins being arranged between the first and second panels, the first direction being parallel to the radial axis.

The invention further relates to an aircraft comprising a turbomachine as mentioned above.

Finally, the invention relates to a method for manufacturing a heat exchanger as mentioned above, the method comprising a step of producing the heat exchanger by additive manufacturing using selective melting on powder beds.

### BRIEF DESCRIPTION OF THE FIGURES

The invention will be better understood, and other purposes, details, characteristics and advantages thereof will become clearer upon reading the following detailed explanatory description of embodiments of the invention given as purely illustrative and non-limiting examples, with reference to the appended schematic drawings in which:

FIG. 1 is a perspective view of a heat exchanger comprising plates and fins according to the invention;

FIG. 2 is an axial cross-sectional view of an example of a turbomachine to which the invention applies;

FIG. 3 is a schematic cross-sectional view of a heat exchanger according to the invention;

FIG. 4 is a perspective view of an example of the fin arrangement of a heat exchanger according to the invention;

FIG. 5 is a radial cross-sectional view of the heat exchanger of FIG. 1 according to the invention; and

FIG. 6 is a side view showing the external periphery of the heat exchanger according to the invention.

### DETAILED DESCRIPTION OF THE INVENTION

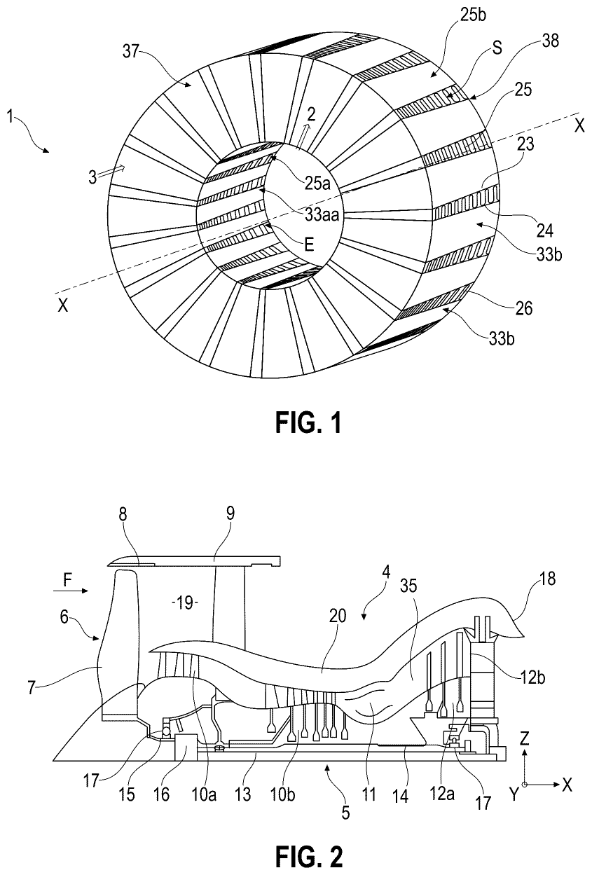

FIG. 1 shows a heat exchanger 1 for transferring thermal energy between a first fluid 2 and a second fluid 3. The heat exchanger 1 is configured to be mounted in an aircraft turbomachine 4. Of course, the heat exchanger 1 may be installed in any system where a thermal energy transfer is required.

FIG. 2 shows, in axial cross-section, a turbofan engine 4 of longitudinal axis X to which the invention may be applied. Of course, other types of turbomachine are also being considered.

The turbofan engine 4 generally comprises a gas generator or a gas turbine engine 5 upstream of which is mounted a fan or fan module 6. In the present invention, the terms “upstream” and “downstream” are defined in relation to the circulation of the gases in the turbomachine and here along the longitudinal axis X and with reference to FIG. 2 from left to right. The fan 6 comprises vanes 7 which are ducted by a fan casing 8. The fan casing 8 carries a nacelle 9. The latter is annular, centered on the longitudinal axis X and connected to the aircraft.

The gas generator 5 comprises, from upstream to downstream, a low-pressure compressor 10a, a high-pressure compressor 10b, an annular combustion chamber 11, and a high-pressure turbine 12a and a low-pressure turbine 12b. Typically, the turbomachine 1 comprises a low-pressure shaft 13 that connects the low-pressure compressor 10a and the low-pressure turbine 12a to form a low-pressure body and a high-pressure shaft 14 that connects the high-pressure compressor 10b and the high-pressure turbine 13a to form a high-pressure body.

The low-pressure shaft 13, centered on the longitudinal axis, drives a fan shaft 15. A speed reducer 16 may be interposed, as here, between the fan shaft 15 and the low pressure shaft 13. Advantageously, rotary guide bearings 17 may also be used to guide the low-pressure shaft 13, the high-pressure shaft 14 and the fan shaft 15 in rotation relative to a stationary structure of the turbomachine.

The guide bearings 17 and the speed reducer 16 in this example configuration of the turbomachine 1 must be lubricated and/or cooled to ensure the performance of the turbomachine. The power generated by these is dissipated in a fluid coming from a fluid supply source installed in the turbomachine, which allows to lubricate and/or cool various members and/or items of equipment of the turbomachine. Other items of equipment of the turbomachine or of the aircraft, such as electrical machines, generators, batteries, accessory gearboxes, electronic/electrical systems and aircraft interior cooling systems, may have a significant thermal energy to transfer.

The heat exchanger 1 is described in more detail below in the context of its installation in a turbomachine and, in this example, allows the first fluid 2 to be cooled by the second fluid 3. In this example, the first fluid 2 comprises the gases leaving the compressor or compressors and the second fluid 3 comprises the exhaust gases from the turbomachine 4 at the level of an ejection nozzle 18. The exhaust gases are used, for example, to heat the gas leaving the compressor or compressors before passing through the combustion chamber. The heat in the exhaust gases is generally lost.

Advantageously, but without limitation, the secondary flow generated by the fan circulates in a secondary duct 19 which is delimited radially by at least the fan casing 8 and an inter-duct casing 20 surrounding the gas generator. The primary flow passing through the gas generator circulates in a primary duct 35 which is delimited radially by at least the inter-duct casing 20 and an internal casing 36 surrounding the gas generator.

The term “radially” or “radial” is defined in relation to a radial axis Z which extends from the longitudinal axis L of the turbomachine 1 and is perpendicular thereto.

The heat exchanger may be located in the secondary duct or alternatively in the primary duct. Alternatively, the heat exchanger may be arranged at the level of the ejection nozzle 18. Advantageously, the heat exchanger may be arranged upstream of the combustion chamber or downstream of the combustion chamber.

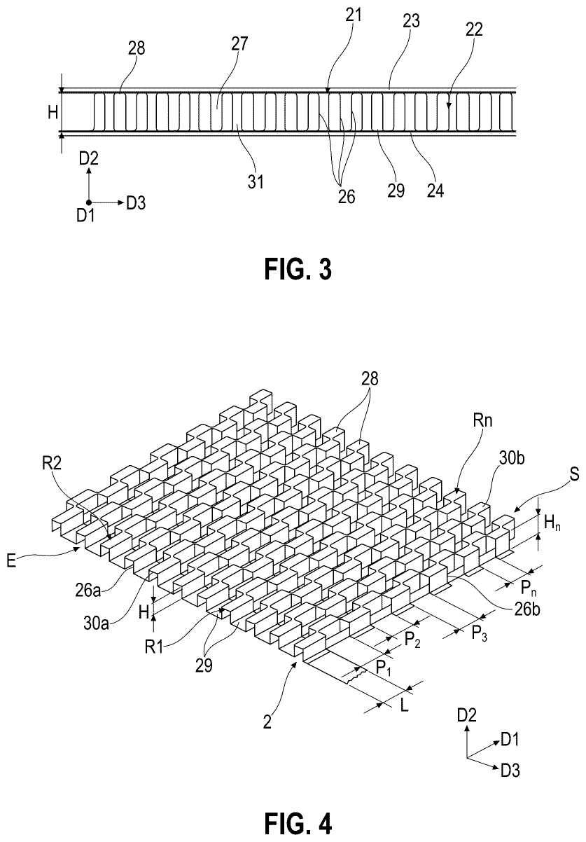

Referring to FIGS. 1 and 3, the heat exchanger 1 comprises a primary exchange surface 21 and a secondary exchange surface 22. The primary exchange surface 21 comprises two panels (or plates) known respectively as a first panel 23 and a second panel 24.

We use the term “direction” to describe the heat exchanger in particular. In the installation situation, the first direction D1 is parallel to the radial axis Z of the turbomachine 1.

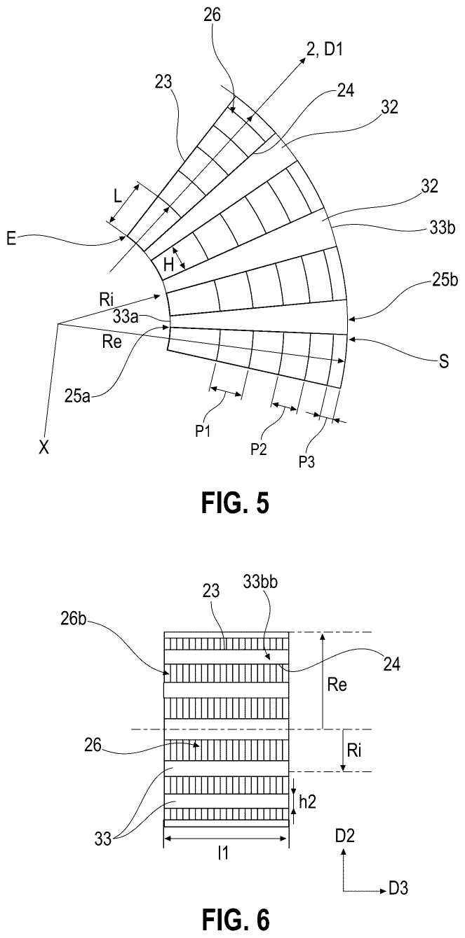

With reference to FIGS. 1 and 5, the annular heat exchanger is centered on a third longitudinal direction D3. In the installation situation, the third direction is centered on the longitudinal axis. The annular shape of the heat exchanger 1 allows it to be better integrated into the turbomachine 4.

The heat exchanger 1 has an inner cylindrical surface 25a defining an inner radius Ri and an outer cylindrical surface 25b defining an outer radius Re. The heat exchanger 1 also has an upstream surface 37 (or front surface) and a downstream surface 38 which are opposite each other along the longitudinal axis. The upstream surface 37 and the downstream surface 38 are connected by the inner and outer cylindrical surfaces 25a, 25b.

The heat exchanger 1 comprises an inlet E through which the first fluid enters the heat exchanger 1. Advantageously, the inlet E is defined at the level of the internal cylindrical surface 25a. The heat exchanger 1 also comprises at least one outlet S through which the first fluid escapes from the heat exchanger. The outlet S is defined here at the level of the outer cylindrical surface 25b.

In FIG. 3, which shows part of the two panels 23, 24 and one stage of the heat exchanger, these are superimposed in a plane D2, D3. The second panel 24 extends above the first panel 23 in a second direction D2 and at a distance from it so as to form a space 27. The second direction D2 is perpendicular to the third direction and to a first longitudinal direction D1. The second direction D2 is also parallel to a circumferential direction around the longitudinal axis X of the turbomachine 1.

The space 27 formed between the two panels 23, 24 allows the first fluid 2 to circulate in the first direction D1. The first fluid 2 may circulate between the inlet E and the outlet S of the heat exchanger 1.

The heat exchanger 1 also comprises a plurality of fins 26 that extend between the first panel 23 and the second panel 24. The fins 26 form the secondary exchange surface 22. The fins 26 extend transversely to the first and second panels 23, 24. More specifically, the fins 26 extend along the second direction D2 between the two panels 23, 24.

The fins 26 form channels 31 through which the first fluid 2 circulates. The first fluid 2 is configured to pass through the fins 26 and flow between the first and second panels 23, 24 in the first direction D1.

FIG. 4 shows the fins 26 of the heat exchanger 1 without the panels 23, 24. The fins 26 are arranged in several rows R1, R2, etc., Rn along a third direction D3. The third direction D3 is perpendicular to the first and second directions D2, D3. The rows of fins 26 are parallel to each other. In this case, the rows R1, R2, Rn of fins 26 are parallel to the third direction D3.

Each fin 26 is generally flat and also extends in the first direction D1. Advantageously, each fin 23 in this example has a generally rectangular shape. Alternatively, the fins 23 have a trapezoidal shape or any other shape, or may be inclined with respect to the second direction D2.

The fins 26 each have a leading edge 26a and a trailing edge 26b for the first fluid 2. The leading edges 26a and trailing edges 26b are opposite each other in the first direction D1. The leading edges 26a and trailing edges 26b delimit the fins 26 longitudinally. The leading edge 26a is the edge via which the first fluid 2 first comes into contact with the fin 26. The trailing edge 26b is the edge with which the first fluid 2 is last in contact with the fin 26. The leading edges 26a and trailing edges 26b extend generally in the second direction.

As shown in FIG. 4, the fins 26 are also staggered. More specifically, the fins 26 are offset in the third direction D3. Advantageously, the fins 26 of every other row lie in the same plane parallel to the plane D2, D3. This arrangement allows to improve the heat exchange by interrupting and evenly reforming the thermal boundary layer on the surface of the fins. The thermal boundary layer is interrupted at the trailing edge of the fin and reformed at the leading edge of the fin.

Advantageously, but without limitation, the fins 26 of each row are connected to each other alternately by a top wall 28 and by a base wall 29. The top walls 28 and the base walls 29 are generally flat and face each other in the second direction D2. The top walls 28 and the base walls 29 extend in the first direction D1. Similarly, the fins 26 of adjacent rows in the first longitudinal direction are connected to each other by means of the top walls 28. These top walls 28 and base walls 29 have a leading edge 30a connected to the leading edges 26a of the fins 26 and a trailing edge 30b connected to the trailing edges 26b of the fins 26.

The fins 26 are attached to the first and second panels 23, 24. Advantageously, the attachment is achieved by means of the top walls 28 and the base walls 29. The attachment may be by welding or brazing.

The heat exchanger 1 may be single-stage or multi-stage. FIG. 2 shows a single stage. One stage is defined by the fins 26 and by the first and second panels 23, 24. In this way, the first fluid 2 circulates through the fins 26, in the channels 31 and in the space 25 between the two panels 23, 24, while the second fluid 3 circulates above the first panel 23 and below the second panel 24. In the case of a multi-stage heat exchanger, the stages would be spaced apart by passages 32 through which the second fluid is configured to circulate. Each passage 32 would be formed between two adjacent panels 23, 24 of different stages.

Advantageously, each fin 26 has a height H measured in the second direction D2 and a length L measured in the first direction D1.

Advantageously, the height H of the fins varies. This variation occurs from the inner cylindrical surface 25a to the outer cylindrical surface 25b. In other words, the height will increase in the radial direction of the heat exchanger. The height of the fins varies linearly with the radius of the heat exchanger (in cylindrical coordinates). The top walls 28 of the fins have radially external surfaces that are flush. As the height varies, the flow speed decreases and the passage cross-sectional area increases. This leads to a reduction in the exchange coefficient.

The length L of the fins 26 varies along the first direction D1. The length L of the fins varies between the inner radius Ri and the outer radius Re of the heat exchanger 1. In particular, the length L of the fins 26 reduces or decreases from the inlet E (inner cylindrical surface) of the heat exchanger to the outlet S (outer cylindrical surface) of the heat exchanger 1. Advantageously, the variation is continuous. In this way, the speed (and therefore the exchange coefficient) varies continuously). This variation in fin length allows to compensate for the reduction in the exchange coefficient. By varying the length of the fins, it is also possible to compensate for the variation in cross-section and a variation in the speed of the flow of the first fluid in the heat exchanger. More precisely, reducing the length of the fins increases the exchange coefficient. This is because there are more fin leading edges in the radial direction and the thermal boundary layer regenerates.

The length L of each fin 26 is between 0.5 mm and 150 mm. Advantageously, the length of the fins close to the axis is between 50 mm and 150 mm and the fins away from the longitudinal axis are between 0.5 mm and 50 mm.

Each fin 26 in each row is located at a distance from the adjacent fin 26 in the first direction D1 and at a specific pitch P. Another advantageous aspect is that the pitch P also varies in the first direction D1. In this example, the variation is a decrease or a reduction in the distance of the pitch from the inlet E of the heat exchanger 1 towards the outlet S of the heat exchanger 1. In other words, the pitch P decreases along the flow of the first fluid 2. By varying the pitch P, a convective thermal resistance is maintained at a relatively constant fluid speed. In particular, this configuration allows to compensate for an increase in fin length by reducing the fin pitch in the first direction D.

The pitch P between each fin 26 is between 0.5 mm and 50 mm. Advantageously, the pitch P close to the longitudinal axis of the heat exchanger is between 5 mm and 50 mm and the pitch away from the longitudinal axis is between 0.5 mm and 5 mm.

Still referring to FIG. 4, the transverse pitch (along the third direction D3) is constant. The transverse pitch is the distance between each row of fins.

FIG. 5 shows a radial cross-section of a heat exchanger 1 mounted in the turbomachine. The heat exchanger 1 is annular and centered on the longitudinal axis X. The heat exchanger 1 has several stages arranged around the longitudinal axis X. The pattern formed by the fins 26 between two panels 23, 24 is non-uniform. The first and second panels 23, 24 each extend along the radial axis in the turbomachine. Between each stage is a passage 32 configured for the circulation of the second fluid. Each passage 32 extends between a radially inner end 32a and a radially outer end 32b. The radially inner end 31a of the passages 32 is arranged on the inner radius Ri of the heat exchanger 1. The radially outer end 32b is arranged on the outer cylindrical surface 25b and the outer radius Re of the heat exchanger 1.

The length L of the fins 26 varies along the first direction D1, which in this case is parallel to the radial axis Z. The length L of the fins 26 increases along the first direction D1 and with the flow of the first fluid 2 (i.e. from the central axis of the heat exchanger 1 towards the position furthest from the center). The pitch P decreases from the heat exchanger inlet towards the heat exchanger 1 outlet. The pitch P1, close to the center of the heat exchanger, is greater than the pitch P2, which is greater than the pitch P3 furthest from the center of the heat exchanger (along the radial axis of the heat exchanger).

In the case of reducing the pitch and increasing the fin length as the fin length L increases, the variation in fin length may be defined linearly as a function of the mean radial coordinate of the fin with the parameter

$${λ}_{r} = \frac{L ( {R}_{min} )}{L ( {R}_{max} )} .$$

In this ratio L is the length of the fin as a function of its radial position in cylindrical coordinates, Rmin is the minimum radius of the heat exchanger defined by the inner cylindrical surface 25a, Rmax is the maximum radius of the heat exchanger defined by the outer cylindrical surface 25b. For example, the parameter λᵣ may be between 1.2 and 1.8. This geometric parameter λᵣ is a ratio between the length of the fins at the level of the inlet (inner cylindrical surface) and the length of the fins at the level of the outlet (outer cylindrical surface).

Alternatively, but without limitation, the fins are 26 corrugated and have offset pitches. When the fins are corrugated, the reduction in the pitch P of the corrugation as the fin length increases allows to compensate for the reduction in the compactness of the heat exchanger by increasing the exchange coefficient. For example, the longitudinal periodicity Pₗ may decrease linearly as a function of the radial coordinate with the reduction parameter

$${λ}_{p 1} = \frac{{P}_{1} ( {R}_{min} )}{{P}_{1} ( {R}_{max} )}$$

where Pₗ is the longitudinal periodicity of the corrugation of the fin as a function of its radial position in cylindrical coordinates. For example, 1.2<λₚₗ<1.8. The longitudinal periodicity corresponds to the length of a fin followed by a pitch. This is the way in which the pattern is repeated along the first direction D1.

Advantageously, the inlet cross-section of the heat exchanger is smaller than the outlet cross-section of the heat exchanger. The cross-section increases linearly with distance from the axis of revolution of the heat exchanger. Advantageously, as the passage cross-section increases, the speed of the first fluid 2 decreases.

FIG. 6 shows a schematic side view of the heat exchanger 1. This figure shows the outlet S of the heat exchanger 1 through which the first fluid 2 flows. This view shows the trailing edges 26b of the fins 26. We may also see covers 33b which are advantageously installed on either side of the fins 26 in the second direction D2. These covers 33b are configured to close off at least some of the passages 32 through which the second fluid 2 circulates. More specifically, each cover 33b is arranged at one end of a passage 31 to close off said end and the passage 32 at that point. In this example, the covers 33b are arranged at the level of the radially outer end 31b of the passages 32. Each cover 33b comprises an outer surface 33bb which forms the outer cylindrical surface 25b.

Advantageously and with reference to FIG. 5, covers 33a are also arranged at the level of the radially inner end 31a of the passages 31. Each cover 33a comprises an outer surface 33aa (see FIG. 1) which forms the outer cylindrical surface 25b.

In this way, the second fluid 3 which enters the heat exchanger 1 at the level of the radially inner end 31a is guided between the two covers 33a, 33b towards another outlet. This prevents the first flow and the second flow from mixing.

Alternatively, the second fluid 3 may circulate through the heat exchanger 1 axially (along the longitudinal axis) or radially (along the radial axis).

Each cover 33a, 33b has a width l1 identical to that of the first and second panels 23, 24. The width l1 is measured in the third direction D3. Each cover 33a, 33b also has a height h2 measured between two panels 23, 24. The radially outer surface of the cover 33b defines the outer radius of the heat exchanger 1, while the radially inner surface of the cover 33a also defines the inner radius of the heat exchanger 1.

Advantageously, the fins 26, the top walls 28 and the first and second panels 23, 24 are formed in one-part (integrally made or monobloc). Advantageously, these are obtained by an additive manufacturing method, in particular selective fusion on powder beds, referred by the acronym SLM for “Selective Laser Melting”. This method is particularly suitable for producing the heat exchanger in a single piece. In particular, the method allows to obtain complex shapes and parts with good strength and mechanical characteristics. The principle of the additive manufacturing SLM is based on the fusion of thin, two-dimensional (2D) layers of powder, such as metal, plastic or ceramic, using a high-power laser.

In this additive manufacturing method, the heat exchanger has no top walls 28 and no base walls 29. The method allows a direct connection of the fins and the first and second panels 23, 24. The additive manufacturing and the absence of these walls means weight savings.

The additive manufacturing is carried out using an SLM installation which generally comprises a supply tank containing a powder and a manufacturing support on which the part to be manufactured, in this case the heat exchanger 1, is produced. The installation also comprises a sweeping element allowing to transfer a quantity of the powder from the supply tank onto the manufacturing support, which is mounted so as to be movable in a vertical translation Z. The installation also comprises an element for generating a laser beam allowing to melt the powder configured to produce the part and means allowing to direct the laser beam towards the support, such as mirrors. A recycling tank allows unused or unfused powder to be recycled.

The method involves manufacturing the part by superimposing layers of powder from the supply tank and transferred onto the manufacturing support. These layers of powder are then melted one after the other as the laser beam moves over the surface of each layer. The temperature of the powder is raised to a temperature above the melting temperature of the powder using the laser beam. The molten layers gradually solidify to form a single block.

Advantageously, the different layers configured to form the heat exchanger are superimposed along a manufacturing axis which is parallel to the third direction D3.

1. A heat exchanger for an aircraft turbomachine, the heat exchanger having a longitudinal axis and comprising:
a plurality of fins configured to be swept by a first fluid in a first direction, the fins extending in a second direction between a first panel and a second panel, the fins being arranged in a plurality of rows in a third direction and being staggered, each row of fins being parallel to one another and connected to one another,
wherein the heat exchanger is annular centered on the third direction and has an inner cylindrical surface defining an inlet to the heat exchanger and an outer cylindrical surface defining an outlet from the heat exchanger, and
wherein the fins have a length which decreases radially in the heat exchanger, in the first direction, between the inner cylindrical surface and the outer cylindrical surface.

2. The heat exchanger according to claim 1, wherein the fins of each row are spaced apart by a pitch in the first direction, wherein the pitch has a variation in the second direction.

3. The heat exchanger according to claim 2, wherein the pitch decreases in the first direction from the inner cylindrical surface towards the outer cylindrical surface.

4. The heat exchanger according to claim 1, wherein each fin has a height which increases from the inner cylindrical surface to the outer cylindrical surface.

5. The heat exchanger according to claim 1, wherein the first panel, the second panel, and the fins between the first and second panels form a stage, and wherein the heat exchanger comprises several stages arranged around the third direction, the stages being spaced apart by passages configured for circulation of a second fluid.

6. The heat exchanger according to claim 5, further comprising covers each closing one end of a passage, the covers extending between the first panel and the second panel.

7. The heat exchanger according to claim 1, wherein the fins are connected alternately by top walls and base walls, wherein the top walls and the base walls are connected respectively to the first and second panels.

8. The heat exchanger according to claim 1, wherein the heat exchanger is formed in one piece.

9. A turbomachine comprising the heat exchanger according to claim 1, with the first and second panels extending, on the one hand, along a radial axis perpendicular to the longitudinal axis and being, on the other hand, arranged regularly around the longitudinal axis, the fins being arranged between the first and second panels, the first direction being parallel to the radial axis.

10. A method for manufacturing the heat exchanger according to claim 1, wherein the method comprises a step of producing the heat exchanger by additive manufacturing using selective melting on powder beds.
